(19) United States
(12) Patent Application Publication
(10) Pub. No.: US 2024/0243428 A1
(43) Pub. Date: Jul. 18, 2024

(54) BATTERY HOUSING, BATTERY PACK, AND VEHICLE

(71) Applicant: BYD COMPANY LIMITED, SHENZHEN (CN)

(72) Inventors: Yuanmao SHU, Shenzhen (CN); Yanfeng WU, Shenzhen (CN); Xiao WANG, Shenzhen (CN); Weixin ZHENG, Shenzhen (CN); Zhipei LU, Shenzhen (CN)

(21) Appl. No.: 18/618,502

(22) Filed: Mar. 27, 2024

Related U.S. Application Data
(63) Continuation of application No. PCT/CN2022/133643, filed on Nov. 23, 2022.

(30) Foreign Application Priority Data
Nov. 30, 2021 (CN) 202122973127.X

(51) Int. Cl. H01M 50/367; H01M 10/613; H01M 10/653; H01M 10/6556; H01M 50/211; H01M 50/213; H01M 50/249; H01M 50/342

(52) U.S. Cl. CPC H01M 50/367; H01M 10/613; H01M 10/653; H01M 10/6556; H01M 50/211; H01M 50/213; H01M 50/249; H01M 50/3425; H01M 2220/20

(57) ABSTRACT

A battery housing includes: a tray including a first channel; an explosion-proof valve disposed on the tray, the first channel being in communication with the explosion-proof valve; at least one module transverse beam disposed in the tray and including an accommodating portion, at least a part of a bottom of the accommodating portion being depressed downward to form a groove, and an opening disposed at at least one end of the groove along a length direction of the module transverse beam; and a liquid cooling plate connected to an outside of a bottom of the module transverse beam, at least one connection channel being formed between the liquid cooling plate and the module transverse beam, and the opening of the at least one module transverse beam being in communication with the first channel through the connection channel.

### CROSS-REFERENCE TO RELATED APPLICATIONS

The application is a continuation application of International Patent Application No. PCT/CN2022/133643 filed on Nov. 23, 2022, which is based on and claims priority to and benefits of Chinese Patent Application No. 202122973127.X, filed on Nov. 30, 2021. The entire content of all of the above-referenced applications is incorporated herein by reference.

### FIELD

The present disclosure relates to the field of battery technologies, and more particularly, to a battery housing, a battery pack, and a vehicle.

### BACKGROUND

Currently, to improve strength of a battery pack, an intermediate beam often needs in the battery pack. However, the intermediate beam occupies a part of space of the battery pack, resulting in a low overall utilization of space of the battery pack. In a solution, the intermediate beam in the battery pack is utilized and a battery module is arranged in the intermediate beam. However, when the battery module is arranged in the intermediate beam, the following problem exists: when a thermal failure occurs in a battery, generated high-temperature and high-pressure gas cannot be cooled and discharged out of the battery pack in time. Consequently, the high-temperature gas accumulates in a short duration and cannot be discharged. As a result, adjacent battery cores or even all battery cores in the entire battery pack easily catch fire due to thermal runaway. Therefore, it is an urgent problem to be resolved to cool and discharge the gas generated by a battery core module in the intermediate beam and improve safety performance of the battery pack.

### SUMMARY

To resolve the foregoing technical problem, the present disclosure provides a battery housing, a battery pack, and a vehicle. The battery housing provided in the present disclosure can cool high-temperature gas generated by a battery core module and quickly and directionally diffuse the gas to a tray, and then discharge the gas out of the battery pack, to protect the battery pack and improve safety of the battery pack.

According to a first aspect of embodiments of the present disclosure, a battery housing is provided. The battery housing includes: a tray including a first channel; an explosion-proof valve disposed on the tray, the first channel being in communication with the explosion-proof valve; at least one module transverse beam disposed in the tray and comprising an accommodating portion, at least a part of a bottom of the accommodating portion being depressed downward to form a groove extending along a length direction of the module transverse beam, and at least one opening disposed at one end of the groove; and a liquid cooling plate connected to an outside of a bottom of the module transverse beam, at least one connection channel being formed between the liquid cooling plate and the module transverse beam, and the opening being in communication with the first channel through the connection channel.

In an embodiment, the module transverse beam includes a first connection portion and a second connection portion. The first connection portion, the accommodating portion, and the second connection portion are connected. The first connection portion and the second connection portion are connected to the tray.

The at least one opening includes a first opening and a second opening are respectively disposed at two ends of the groove.

A second channel is formed between the first connection portion and the liquid cooling plate, and a third channel is formed between the second connection portion and the liquid cooling plate.

A first end of the second channel is in communication with the first opening, and a first end of the third channel is in communication with the second opening.

In an embodiment, a first communicating port and a second communicating port are respectively disposed at the first connection portion and the second connection portion, a second end of the second channel is in communication with a first end of the first communicating port, a second end of the third channel is in communication with a first end of the second communicating port, and a second end of the first communicating port and a second end of the second communicating port are in communication with the first channel.

In an embodiment, the second channel includes a first connection channel and a second connection channel disposed on two sides extending in the length direction of the module transverse beam, and the third channel comprises a third connection channel and a fourth connection channel disposed on the two sides extending in the length direction of the module transverse beam.

A first end of the first connection channel and a first end of the second connection channel are in communication with the first opening, and a second end of the third connection channel and a second end of the fourth connection channel are in communication with the second opening. The first communicating port and the second communicating port are disposed at the first connection portion and the second connection portion. The a second end of the first connection channel and a second end of the second connection channel are in communication with a first end of the first communicating port. The second end of the third connection channel and the second end of the fourth connection channel are in communication with a first end of the second communicating port. The a second end of the first communicating port and a second end of the second communicating port are in communication with the first channel.

In an embodiment, the first connection channel is in communication with the third connection channel as an integrated channel, and the second connection channel is in communication with the fourth connection channel as an integrated channel.

In an embodiment, a depth of the groove is 3 mm to 5 mm, a difference between a length of an accommodating base and a length of the groove is 15 mm to 35 mm, and a difference between the width of the accommodating base and a width of the groove is 15 mm to 35 mm.

In an embodiment, the bottom of the module transverse beam is connected to the liquid cooling plate by a thermally conductive structural adhesive.

In an embodiment, the module transverse beam is a metal component.

In an embodiment, the module transverse beam is made of aluminum alloy.

According to a second aspect of embodiments of the present disclosure, a battery pack is provided. The battery pack includes a battery core module and the battery housing described in the first aspect, where the battery core module is disposed in the accommodating portion.

In an embodiment, the battery core module includes a number of battery cores, a pre-positioning bracket, and a housing. An opening is disposed at a bottom of the housing, and the pre-positioning bracket blocks the opening at the bottom of the housing to form an accommodating space for accommodating the battery cores. A number of battery core positioning portions are disposed on one side of the pre-positioning bracket located in the accommodating space, and the battery cores are respectively disposed in the number of battery core positioning portions.

In an embodiment, the battery core module further includes a positive connection board and a negative connection board and a negative connection board respectively located on two sides of the pre-positioning bracket, and the positive connection board and the negative connection board are insulated from each other; and a through groove is disposed at a bottom wall of the battery core positioning portions, and a positive electrode or a negative electrode of a battery core is connected to the positive connection board or the negative connection board through the through groove.

In an embodiment, the battery cores, the housing, the pre-positioning bracket, the positive connection board, and the negative connection board are secured and connected by a sealant disposed therebetween.

In an embodiment, a sealant-resistant foam is disposed between the battery core module and the module transverse beam, a step portion is disposed around the groove in the accommodating portion, and the sealant-resistant foam is coupled with and in contact with the step portion.

In an embodiment, an opening of the sealant-resistant foam corresponds to an opening of the groove.

In an embodiment, the battery core module is at least a ternary lithium battery core module or a polymer lithium battery core module.

In an embodiment, the battery cores include a cylindrical battery or a soft-pack battery.

In an embodiment, a pressure relief valve is disposed at the battery core module toward the groove.

According to a third aspect of embodiments of the present disclosure, a vehicle is provided. The vehicle includes the battery pack described in the second aspect.

In an embodiment, the vehicle is an electric vehicle or a hybrid vehicle.

A technical effect of the present disclosure is that embodiments of the present disclosure provide a battery housing. The groove for accommodating high-temperature and high-pressure gas generated due to thermal runaway of the battery core is arranged/disposed at the bottom of the accommodating portion of the module transverse beam. The bottom of the module transverse beam is connected with the liquid cooling plate that can quickly cool the high-temperature and high-pressure gas. The opening for discharging the high-temperature and high-pressure gas is arranged/disposed at an end part of the groove. The discharged high-temperature and high-pressure gas is directionally discharged into the first channel in the tray through the connection channel and is discharged out of the battery pack through the explosion-proof valve. Because the gas is discharged directionally, another battery core in the battery pack is not affected by the gas. The battery housing in the present disclosure can cool in time, and the high-temperature and high-pressure gas that is generated due to a thermal failure of the battery core can quickly and directionally be discharged out of the battery pack, to protect the battery pack and improve the safety of the battery pack.

Other features and advantages of the present disclosure are more clearly based on the following detailed descriptions of example embodiments of the present disclosure with reference to the accompanying drawings.

### BRIEF DESCRIPTION OF THE DRAWINGS

Accompanying drawings constitute a part of the specification, describe embodiments in the present disclosure, and are used together with the specification to describe the principle of the present disclosure.

FIG. 1 is a schematic diagram of a structure of a battery pack according to an embodiment of the present disclosure;

FIG. 2 is a schematic partial diagram of a structure of a battery pack according to an embodiment of the present disclosure;

FIG. 3 is an exploded view of a structure of a battery pack according to an embodiment of the present disclosure;

FIG. 4 is a schematic diagram of a structure of a pre-positioning bracket according to an embodiment of the present disclosure;

FIG. 5 is a schematic diagram of a structure in which a module transverse beam and a battery core module are secured according to an embodiment of the present disclosure;

FIG. 6 is a cross-sectional view of a plane A-A shown in FIG. 5;

FIG. 7 is a schematic diagram of a gas flow direction in a groove according to an embodiment of the present disclosure; and

FIG. 8 is a schematic partial diagram in which gas in a groove flows to a first connection portion according to an embodiment of the present disclosure.

### DESCRIPTION OF REFERENCE NUMERALS

1: battery core module; 11: battery core; 12: pre-positioning bracket; 121: battery core positioning portion; 122: through groove; 13: housing; 14: positive connection board; 15: negative connection board; 16: pouring sealant; 17: outlined-rectangle sealant-resistant foam;
2: tray; 21: first channel; 22: explosion-proof valve;
3: module transverse beam; 31: accommodating portion; 311: step portion; 312: groove; 3121: first opening; 3122: second opening; 32: first connection portion; 321: first connection channel; 322: second connection channel; 323: first communicating port; 33: second connection portion; 331: third connection channel; 332: fourth connection channel; 333: second communicating port; 34: thermally conductive structural adhesive; and
4: liquid cooling plate.

### DETAILED DESCRIPTION

Various example embodiments of the present disclosure now are described in detail with reference to the accompanying drawings. It should be noted that, unless otherwise specified, relative arrangement, numerical expressions, and numerical values of components and steps described in the embodiments do not limit the scope of the present disclosure.

The following descriptions of at least one example embodiment are merely illustrative, and do not constitute any limitation on the present disclosure and application or use thereof.

Technologies and devices known to those of ordinary skill in related arts may not be discussed in detail, but in an appropriate case, the technologies and the devices should be considered as a part of the specification.

In all examples shown and discussed herein, any value should be construed merely as examples but not as limitations. Therefore, another example of example embodiments may have different values.

It should be noted that, similar reference signs or letters in the following accompanying drawings indicate similar items. Therefore, once an item is defined in one accompanying drawing, the item does not need to be further discussed in the subsequent accompanying drawings.

According to a first aspect of the present disclosure, a battery housing is provided. Refer to FIG. 1. The battery housing includes a tray 2, at least one module transverse beam 3, and a liquid cooling plate 4. The module transverse beam 3 is arranged/disposed in the tray 2.

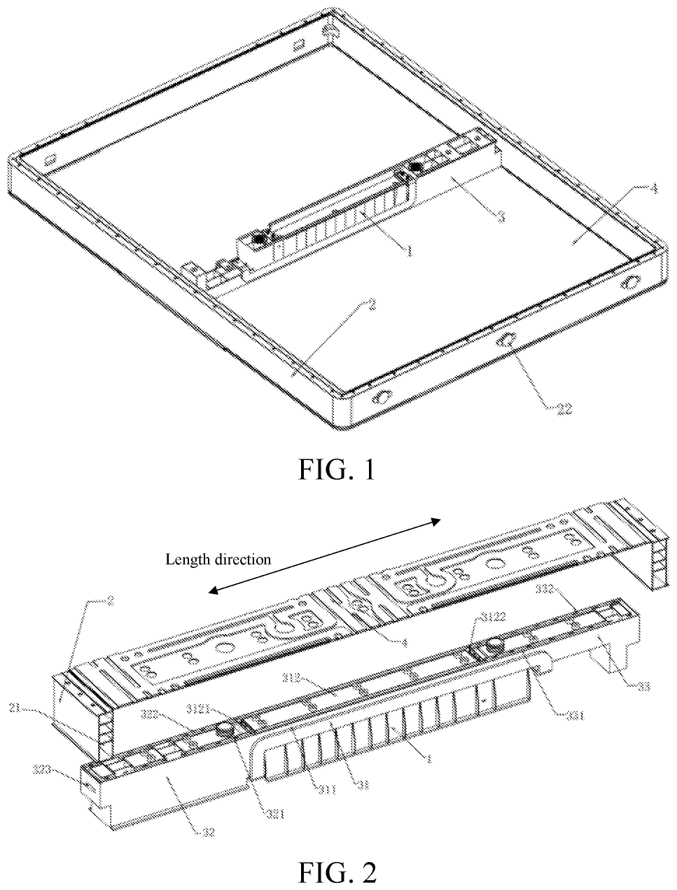

As shown in FIG. 2, the module transverse beam 3 includes an accommodating portion 31. At least a part of a bottom of the accommodating portion 31 is depressed downward to form a groove 312 that extends along a length direction of the module transverse beam and can accommodate gas. An opening is arranged/disposed at at least one end that is of the groove 312 and that is along a length direction of the module transverse beam 3.

The liquid cooling plate 4 is hermetically connected to an outside of a bottom of the module transverse beam 3. At least one connection channel is formed between the liquid cooling plate 4 and the module transverse beam 3. The opening of the groove is in communication with a first channel 21 through the connection channel.

In the battery housing provided in this embodiment of the present disclosure, when a battery core generates high-temperature and high-pressure gas due to thermal runaway. The high-temperature and high-pressure gas breaks through a battery core module and enters the groove, and is cooled by the liquid cooling plate. Initially cooled gas quickly diffuses to the opening of the groove, and directionally diffuses to the tray through the connection channel. The gas breaks through an explosion-proof valve 22 and is discharged out of a battery pack. The battery housing in the present disclosure can cool in time, and the high-temperature and high-pressure gas is generated by the battery core and can be quickly and directionally discharged out of the battery pack through the connection channel and the first channel 21, to avoid a case that an adjacent battery core catches fire because the thermal runaway also occurs due to a high-temperature caused by the thermal diffusion of the battery core. It is ensured that thermal runaway of a single battery core does not expand and spread to the entire battery pack, and safety of the entire battery pack and safety of an electric vehicle passenger are ensured. In conclusion, the battery housing in the present disclosure can cool in time, and the high-temperature and high-pressure gas is generated by the battery core due to a thermal failure and can be quickly and directionally discharged out of the battery pack, to protect the battery pack and improve safety of the battery pack.

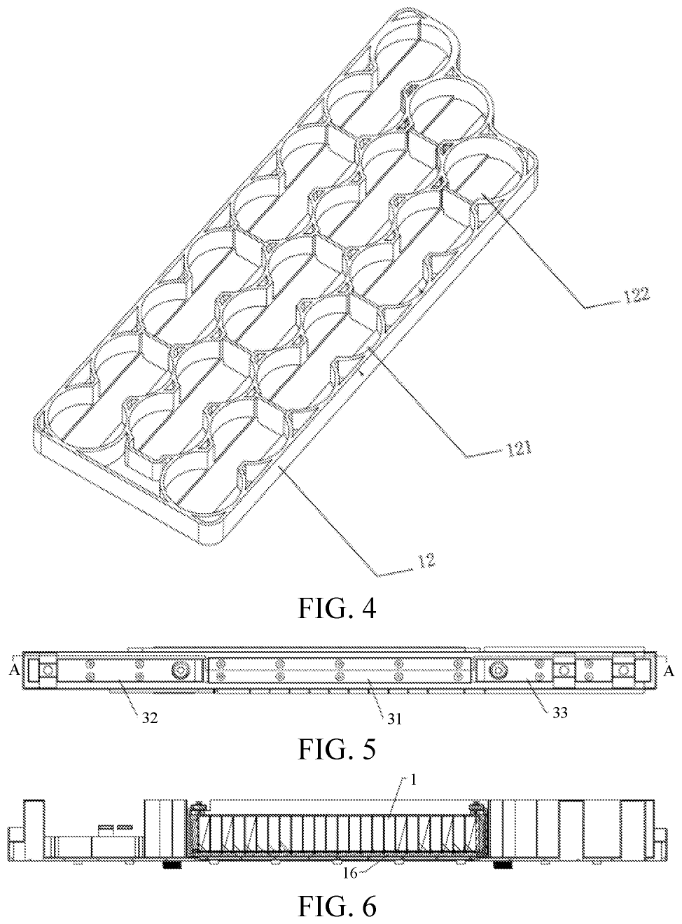

In an embodiment of the present disclosure, as shown in FIG. 2 and FIG. 4, the module transverse beam 3 includes a first connection portion 32 and a second connection portion 33. The first connection portion 32, the accommodating portion 31, and the second connection portion 33 are secured and connected in sequence. The first connection portion 32 and the second connection portion 33 are connected to a tray 2.

A first opening 3121 and a second opening 3122 are respectively arranged/disposed at two ends that are of the groove 312 and that are along the length direction of the module transverse beam 3.

A second channel is formed between the first connection portion 32 and the liquid cooling plate 4 along the length direction of the module transverse beam 3. A third channel is formed between the second connection portion 33 and the liquid cooling plate 4 along the length direction of the module transverse beam 3.

One end (e.g., a first end) of the second channel is in communication with the first opening 3121, and one end of (e.g., a first end) the third channel is in communication with the second opening 3122. A first communicating port 323 and a second communicating port 333 are respectively provided/disposed at the first connection portion 32 and the second connection portion 33. The other end (e.g., a second end) of the second channel is in communication with one end (e.g., a first end) of the first communicating port 323, and the other end (e.g., a second end) of the third channel is in communication with one end (e.g., a first end) of the second communicating port 333. The other end (e.g., a second end) of the first communicating port 323 and the other end (e.g., a second end) of the second communicating port 333 are in communication with the first channel 21.

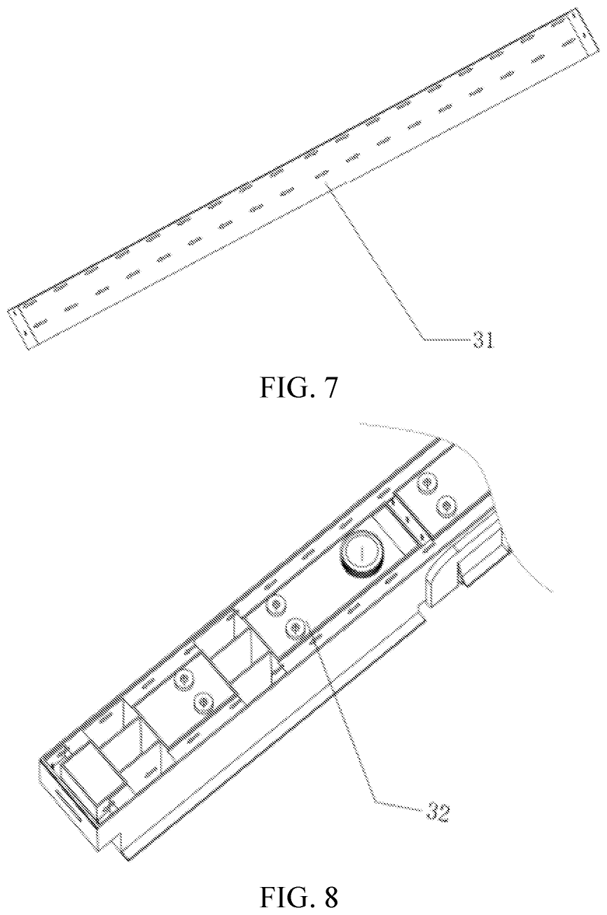

In an embodiment of the present disclosure, the second channel includes a first connection channel 321 and a second connection channel 322 arranged/disposed on two sides extending in the length direction of the module transverse beam 3. The third channel includes a third connection channel 331 and a fourth connection channel 332 arranged on the two sides extending in the length direction of the module transverse beam 3. One end (e.g., a first end) of the first connection channel 321 and one end (e.g., a first end) of the second connection channel 322 are respectively in communication with the first opening 3121. One end (e.g., a first end) of the third connection channel 331 and one end (e.g., a first end) of the fourth connection channel 332 are in communication with the second opening 3122. The first communicating port 323 and the second communicating port 333 are respectively provided at the first connection portion 32 and the second connection portion 33. The other end (e.g., a second end) of the first connection channel 321 and the other end (e.g., a second end) of the second connection channel 322 are in communication with one end of the first communicating port 323. The other end (e.g., a second end) of the third connection channel 331 and the other end (e.g., a second end) of the fourth connection channel 332 are in communication with one end (e.g., a first end) of the second communicating port 333. The other end (e.g., a second end) of the first communicating port 323 and the other end (e.g., a second end) of the second communicating port 333 are in communication with the first channel 21. In this embodiment of the present disclosure, the battery core module is located in the middle of the module transverse beam, and connection channels are arranged/disposed at two ends of the battery core module. When a battery core generates high-temperature and high-pressure gas due to thermal runaway, after a liquid cooling plate initially cools the high-temperature and high-pressure gas, the gas may quickly diffuse to the openings at the two ends of the groove, directionally diffuse to a channel on the tray through the connection channel of the connection portion, breaks through the explosion-proof valve 22, and is discharged out of the battery pack. In this embodiment of the present disclosure, after the high-temperature and high-pressure gas generated by the battery core module enters the groove, where as shown in FIG. 7, a direction of an arrow in the figure represents a gas flow direction, the gas diffuses from the middle to the two ends of the groove, and is in communication with the connection channel of the connection portion through the first opening and the second opening. As shown in FIG. 8, a direction of an arrow in the figure represents a gas flow direction. The gas diffuses from the groove through the first opening. After diffusing from the first opening, the gas diffuses from a middle of the first opening to the first connection channel and the second connection channel that are on two sides. In this way, the gas is diffused in a short distance and has a diffusion direction, so that the gas can be discharged out of the battery pack faster and safety of the battery pack is better ensured.

In an embodiment of the present disclosure, the first connection channel 321 is in communication with the third connection channel 331 to form an integrated channel, and the second connection channel 322 is in communication with the fourth connection channel 332 to form an integrated channel. In this embodiment of the present disclosure, there is a channel on each of the two sides along the direction of the module transverse beam, and the channels are respectively in communication with the first connection portion, the accommodating portion, and the second connection portion. In other words, the channel on each side is integrated. In this way, a formed structure of the module transverse beam is simple. After diffusing from the first opening or the second opening, the gas generated due to thermal runaway may diffuse to left or right through the channel.

In an embodiment of the present disclosure, a depth of the groove is 3 mm to 5 mm, such as 3 mm, 3.5 mm, 4 mm, 4.5 mm, or 5 mm. A difference between a length of an accommodating base and a length of the groove is 15 mm to 35 mm, such as 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, or 35 mm. In an embodiment of the present disclosure, the length of the accommodating base may be 580 mm, and the length of the groove may be 550 mm. A difference between a width of the accommodating base and a width of the groove is 15 mm to 35 mm, such as 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, or 35 mm. In an embodiment of the present disclosure, the width of the accommodating base may be 80 mm, and the width of the groove may be 50 mm. When the depth, width, and length of the groove are within the foregoing ranges, rapid gas diffusion can be ensured while space of the battery pack is minimized.

In an embodiment of the present disclosure, the bottom of the module transverse beam 3 is connected to the liquid cooling plate 4 by using a thermally conductive structural adhesive 34. On one hand, the thermally conductive structural adhesive 34 can be used to secure and connect the liquid cooling plate 4 to the module transverse beam. On the other hand, the thermally conductive structural adhesive can be used to transfer a temperature of gas generated due to thermal runaway to the liquid cooling plate for cooling as quickly as possible. In other words, a function of the thermally conductive structural adhesive 34 is to ensure a connection between the module transverse beam and the liquid cooling plate while transferring the temperature to the liquid cooling plate for cooling as quickly as possible.

In an embodiment of the present disclosure, the module transverse beam is a metal component. For example, the module transverse beam 3 is made of aluminum alloy, and an entire weight of the battery pack is reduced.

According to a second aspect of the present disclosure, a battery pack is provided. Refer to FIG. 1. The battery pack includes: a battery core module 1 and the battery housing provided in the first aspect.

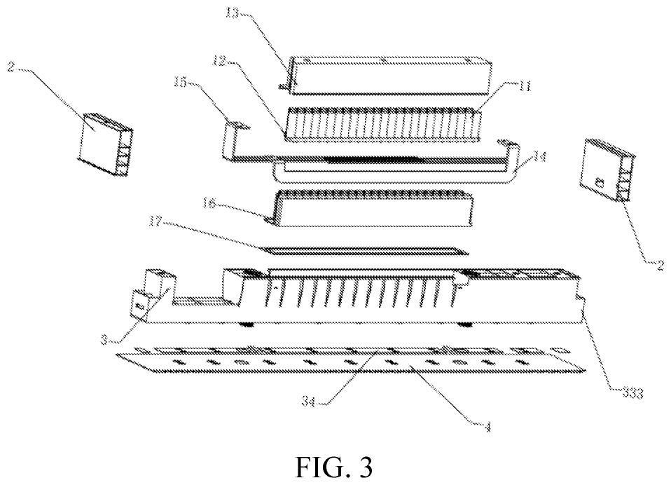

In an embodiment of the present disclosure, as shown in FIG. 3 and FIG. 4, the battery core module 1 includes a number of battery cores 11, a pre-positioning bracket 12, and a housing 13. There is an opening at a bottom of the housing 13, and the pre-positioning bracket 12 stops at and blocks the opening at the bottom of the housing 13 to form an accommodating space for accommodating the battery cores. The battery cores 11 are in the accommodating space. A number of battery core positioning portions 121 are arranged on one side that is of the pre-positioning bracket 12 and that is located in the accommodating space, and the number of battery cores 11 are respectively arranged/disposed in the number of battery core positioning portions 121.

In an embodiment of the present disclosure, as shown in FIG. 3 and FIG. 4, the battery core module 1 further includes a positive connection board 14 and a negative connection board 15. The positive connection board 14 and the negative connection board 15 are respectively located on two sides of the pre-positioning bracket 12, and the positive connection board 14 and the negative connection board 15 are insulated from each other. A through groove 122 is arranged at a bottom wall of the battery core positioning portion 121, and a positive electrode or a negative electrode of the battery core 11 is connected to the positive connection board 14 or the negative connection board 15 through the through groove 122.

In an embodiment of the present disclosure, as shown in FIG. 3 and FIG. 4, a pouring sealant 16 is arranged/disposed between the battery core 11, the housing 13, the pre-positioning bracket 12, the positive connection board 14, and a negative connection board 15. The number of battery cores 11, the housing 13, the pre-positioning bracket 12, the positive connection board 14, and the negative connection board 15 are hermetically and secured and connected by using the pouring sealant 16.

In the present disclosure, an assembly process of the battery core module 1 is as follows: First, the battery core 11 is initially secured in the pre-positioning bracket 12 by using the battery core positioning portion 121, where a positive electrode or a negative electrode of a battery is connected to the positive connection board or the negative connection board respectively through the through groove. Then, the pouring sealant is injected into the housing. As shown in FIG. 5 and FIG. 6, the pouring sealant is filled into gaps between the housing, the battery core, the pre-positioning bracket 12, the positive connection board 14, and the negative connection board 15 and is used to fix the housing, the battery core, the pre-positioning bracket 12, the positive connection board 14, and the negative connection board 15 together to form the battery core module 1 with an integrated structure.

In an embodiment of the present disclosure, as shown in FIG. 3, a sealant-resistant form, such as an outlined-rectangle sealant-resistant foam 17, is arranged/disposed between the battery core module 1 and the module transverse beam 3. A step portion 311 is arranged around the groove 312 in the accommodating portion. A shape of the outlined-rectangle sealant-resistant foam 17 is consistent with a shape of the step portion 311, and the outlined-rectangle sealant-resistant foam 17 is contacted with the step portion 311. In other words, a shape and size of an opening of the outlined-rectangle sealant-resistant foam 17, such as an outlined-rectangle opening of the outlined-rectangle sealant-resistant foam 17 is the same as a shape and size of an opening of the groove 312, so that the groove 312 is exposed from the outlined-rectangle sealant-resistant foam 17.

In an embodiment of the present disclosure, when the battery core module is arranged/disposed in the module transverse beam, the battery core module serves as an entirety and is hermetically contacted with the step portion with the outlined-rectangle sealant-resistant foam. An outlined-rectangle opening of the outlined-rectangle sealant-resistant foam corresponds to an opening of the groove. When a pouring sealant is filled into the battery pack later, due to an effect of the outlined-rectangle sealant-resistant foam, the pouring sealant does not enter the groove, to facilitate high-temperature and high-pressure gas to quickly diffuse into the groove when thermal runaway occurs later.

In an embodiment of the present disclosure, the battery core module is at least one of a ternary lithium battery core module and a polymer lithium battery core module. The battery core module is formed by connecting a number of battery cores, and the battery core is a cylindrical battery or a soft-pack battery.

In an embodiment of the present disclosure, a pressure relief valve is arranged/disposed on the battery core module, and the pressure relief valve is arranged toward the groove. When the battery core module generates high-temperature gas due to thermal runaway, the high-temperature gas flows into the groove through the pressure relief valve.

According to a third aspect of the present disclosure, a vehicle is provided. The vehicle includes the battery pack in the first aspect. For example, the vehicle may be a pure electric vehicle or a hybrid vehicle such as a car, a bus, or a truck. The present disclosure improves use safety of the vehicle.

The foregoing embodiments describe emphatically differences between embodiments. Provided that different optimization features between embodiments are consistent, embodiments can be combined to form a better embodiment. In consideration of simplicity of writing, details are not described herein.

Although some embodiments of the present disclosure have been described in detail by using examples, a person skilled in the art should understand that the foregoing examples are merely for description and are not to limit the scope of the present disclosure. A person skilled in the art should understand that modifications may be made to the foregoing embodiments without departing from the scope and spirit of the present disclosure. The scope of the present disclosure is limited by the appended claims.

What is claimed is:

1. A battery housing, comprising:
a tray comprising a first channel;
an explosion-proof valve disposed on the tray, the first channel being in communication with the explosion-proof valve;
at least one module transverse beam disposed in the tray and comprising an accommodating portion, at least a part of a bottom of the accommodating portion being depressed downward to form a groove extending along a length direction of the module transverse beam, and at least one opening disposed at one end of the groove; and
a liquid cooling plate connected to an outside of a bottom of the module transverse beam, at least one connection channel being formed between the liquid cooling plate and the module transverse beam, and the opening being in communication with the first channel through the connection channel.

2. The battery housing according to claim 1, wherein
the module transverse beam comprises a first connection portion and a second connection portion,
the first connection portion, the accommodating portion, and the second connection portion are connected, and
the first connection portion and the second connection portion are connected to the tray;
the at least one opening comprises a first opening and a second opening respectively disposed at two ends of the groove;
a second channel is formed between the first connection portion and the liquid cooling plate, and a third channel is formed between the second connection portion and the liquid cooling plate; and
a first end of the second channel is in communication with the first opening, and a first end of the third channel is in communication with the second opening.

3. The battery housing according to claim 2, wherein a first communicating port and a second communicating port are respectively disposed at the first connection portion and the second connection portion, a second end of the second channel is in communication with a first end of the first communicating port, a second end of the third channel is in communication with a first end of the second communicating port, and a second end of the first communicating port and a second end of the second communicating port are in communication with the first channel.

4. The battery housing according to claim 3, wherein
the second channel comprises a first connection channel and a second connection channel disposed on two sides extending in the length direction of the module transverse beam, and the third channel comprises a third connection channel and a fourth connection channel disposed on the two sides extending in the length direction of the module transverse beam;
a first end of the first connection channel and a first end of the second connection channel are in communication with the first opening;
a second end of the third connection channel and a second end of the fourth connection channel are in communication with the second opening;
the first communicating port and the second communicating port are disposed at the first connection portion and the second connection portion;
a second end of the first connection channel and a second end of the second connection channel are in communication with a first end of the first communicating port;
the second end of the third connection channel and the second end of the fourth connection channel are in communication with a first end of the second communicating port; and
a second end of the first communicating port and a second end of the second communicating port are in communication with the first channel.

5. The battery housing according to claim 4, wherein the first connection channel is in communication with the third connection channel as an integrated channel, and the second connection channel is in communication with the fourth connection channel as an integrated channel.

6. The battery housing according to claim 1, wherein a depth of the groove is 3 mm to 5 mm, a difference between a length of an accommodating base and a length of the groove is 15 mm to 35 mm, and a difference between a width of the accommodating base and a width of the groove is 15 mm to 35 mm.

7. The battery housing according to claim 1, wherein the bottom of the module transverse beam is connected to the liquid cooling plate by a thermally conductive structural adhesive.

8. The battery housing according to claim 1, wherein the module transverse beam is a metal component.

9. The battery housing according to claim 8, wherein the module transverse beam is made of aluminum alloy.

10. A battery pack, comprising a battery core module and a battery housing, the battery housing comprising:
a tray comprising a first channel;
an explosion-proof valve disposed on the tray, first channel being in communication with the explosion-proof valve;
at least one module transverse beam disposed in the tray and comprising an accommodating portion, at least a part of a bottom of the accommodating portion being depressed downward to form a groove extending along a length direction of the module transverse beam, and at least one opening disposed at one end of the groove; and
a liquid cooling plate connected to an outside of a bottom of the module transverse beam, at least one connection channel being formed between the liquid cooling plate and the module transverse beam, and the opening being in communication with the first channel through the connection channel; and
the battery core module disposed in the accommodating portion.

11. The battery pack according to claim 10, wherein
the battery core module comprises a plurality of battery cores, a pre-positioning bracket, and a housing;
an opening is disposed at a bottom of the housing, and the pre-positioning bracket blocks the opening at the bottom of the housing to form an accommodating space for accommodating the battery cores; and
a plurality of battery core positioning portions are disposed on one side of the pre-positioning bracket located in the accommodating space, and the battery cores are respectively disposed in the battery core positioning portions.

12. The battery pack according to claim 11, wherein the battery core module further comprises a positive connection board and a negative connection board respectively located on two sides of the pre-positioning bracket, and the positive connection board and the negative connection board are insulated from each other; and a through groove is disposed at a bottom wall of the battery core positioning portions, and a positive electrode or a negative electrode of a battery core is connected to the positive connection board or the negative connection board through the through groove.

13. The battery pack according to claim 12, wherein the battery cores, the housing, the pre-positioning bracket, the positive connection board, and the negative connection board are secured and connected by a sealant disposed therebetween.

14. The battery pack according to claim 13, wherein a sealant-resistant foam is disposed between the battery core module and the module transverse beam, a step portion is disposed around the groove in the accommodating portion, and the sealant-resistant foam is coupled with and in contact with the step portion.

15. The battery pack according to claim 14, wherein an opening of the sealant-resistant foam corresponds to an opening of the groove.

16. The battery pack according to claim 10, wherein the battery core module is a ternary lithium battery core module or a polymer lithium battery core module.

17. The battery pack according to claim 11, wherein the battery cores comprise a cylindrical battery or a soft-pack battery.

18. The battery pack according to claim 10, wherein a pressure relief valve is disposed at the battery core module toward the groove.

19. A vehicle, comprising a battery pack, the battery pack comprising a battery core module and a battery housing, the battery housing comprising:
a tray comprising a first channel;
an explosion-proof valve disposed on the tray, the first channel being in communication with the explosion-proof valve;
at least one module transverse beam disposed in the tray and comprising an accommodating portion, at least a part of a bottom of the accommodating portion being depressed downward to form a groove extending along a length direction of the module transverse beam, and at least one opening disposed at one end of the groove; and
a liquid cooling plate connected to an outside of a bottom of the module transverse beam, at least one connection channel being formed between the liquid cooling plate and the module transverse beam, and the opening being in communication with the first channel through the connection channel; and
the battery core module disposed in the accommodating portion.

20. The vehicle according to claim 19, wherein the vehicle is an electric vehicle or a hybrid vehicle.
